(19) United States
(12) Patent Application Publication
(10) Pub. No.: US 2006/0242236 A1
(43) Pub. Date: Oct. 26, 2006

(54) System and method for extensible computer assisted collaboration

(75) Inventors: Todd R. Manion, Redmond, WA (US); Daniel W. Crevier, Bellevue, WA (US); David G. Thaler, Redmond, WA (US); Gursharan S. Sidhu, Seattle, WA (US); Rohit Gupta, Redmond, WA (US); Sandeep K. Singhal, Kirkland, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: Microsoft Corporation, Redmond, WA (US)

(21) Appl. No.: 11/113,218

(22) Filed: Apr. 22, 2005

(51) Int. Cl. G06F 15/16

(52) U.S. Cl. 709/204

(57) ABSTRACT

A collaborative services platform may include a connectivity service, an activity service and a contact management service. The connectivity service may provide communicative connectivity between users of the collaborative services platform. The activity service may provide one or more collaborative activities supporting various modes of communication. The contact management service may maintain contact information for each of the users of the collaborative service platform. It may be that not every user is capable of participating in every collaborative activity. The contact information maintained by the contact management service may indicate the collaborative activities in which each user is capable of participating. A set of programmatic objects utilized to implement the collaborative services platform may include contact objects, conference objects, MeContact objects, endpoint objects, published objects and presence objects. The presence object may represent a presence of a particular user in a networked computing environment and may reference multiple collaborative endpoints.

### FIELD OF THE INVENTION

This invention pertains generally to networked computing environments and, more particularly, to facilitated collaboration in networked computing environments.

### BACKGROUND OF THE INVENTION

Networked computing environments have become common features of the workplace and even the home. These environments facilitate a variety of modes of communication including electronic mail, instant messaging, multimedia document servers, discussion groups, as well as streaming audio and video, and immersive interactive sensory environments. Conventional software applications have begun to take advantage of these rich modes of communication, but each has limitations and/or disadvantages when considered from the point of view of an integrated and extensible computerized collaboration platform.

Some conventional computer software applications provide aspects of collaborative services, but fail to provide effective access to collaborators. Clumsy and/or limited access to collaborators can present barriers to collaboration initiation, preventing the use of otherwise functional collaboration tools. An aspect of ineffective access to collaborators is a failure by some conventional software applications to effectively discern current physical and/or virtual location. Another aspect is a failure by some conventional software applications to effectively discern compatibilities with respect to collaborative functionality.

Beyond deficits in functionality of particular releases of conventional software applications providing aspects of collaborative services, some conventional software applications fail to provide for an extensible collaboration platform, framework, and/or architecture. This is no minor failing. An effective architecture may last many years and be incorporated into network computing environments with millions of nodes. Failures of extensibility, flexibility, maintainability and/or scalability of an established architecture may be a much more significant problem than for a single software product release.

### BRIEF SUMMARY OF THE INVENTION

This section presents a simplified summary of some embodiments of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In an embodiment of the invention, a collaborative services platform includes a connectivity service, an activity service and a contact management service. The connectivity service may provide communicative connectivity between users of the collaborative services platform. The activity service may provide one or more collaborative activities supporting various modes of communication. The contact management service may maintain contact information for each of the users of the collaborative service platform. It may be that not every user is capable of participating in every collaborative activity. The contact information maintained by the contact management service may indicate the collaborative activities in which each user is capable of participating.

In an embodiment of the invention, a set of programmatic objects utilized to implement the collaborative services platform include one or more contact objects, one or more conference objects and a MeContact object. The contact objects may represent users of the collaborative services platform. The conference objects may represent collaborative conferences in which the users represented by the contact objects are capable of participating. The MeContact object may also represent a user of the collaborative services platform, however, this representation may differ from the contact object representation. For example, the MeContact object may reference one or more of the contact objects in the set of programmatic objects representing other users, whereas the contact object need not reference other contact objects. In addition, the MeContact object may reference one or more of the conference objects associated with collaborative conferences, for example, in which the user associated with the MeContact object is currently participating.

In an embodiment of the invention, a set of programmatic objects utilized to implement the collaborative services platform include one or more endpoint objects, one or more published objects and a presence object. The endpoint objects may represent locations in a networked computing environment. The published objects may represent data published to users of the collaborative services platform. The presence object may represent a presence of a particular user in the networked computing environment. The presence object may reference one or more of the endpoint objects, thus indicating networked computing environment locations included in the presence. In addition, the presence object may reference one or more of the published objects, each of which may contribute to a rich presence description.

### BRIEF DESCRIPTION OF THE DRAWINGS

While the appended claims set forth the features of the invention with particularity, the invention and its advantages are best understood from the following detailed description taken in conjunction with the accompanying drawings, of which:

FIG. 1 is a schematic diagram generally illustrating an exemplary computer system usable to implement an embodiment of the invention;

FIG. 2 is a schematic diagram depicting an example networked computing environment suitable for incorporating an embodiment of the invention;

FIG. 3 is a block diagram depicting an example computer software architecture for a collaboration services platform in accordance with an embodiment of the invention;

FIG. 4 is an object modeling diagram depicting an example collaboration object model in accordance with an embodiment of the invention;

FIG. 5 is an object interface diagram depicting an example contact object in accordance with an embodiment of the invention;

FIG. 6 is an object interface diagram depicting an example presence object in accordance with an embodiment of the invention;

FIG. 7 is an object interface diagram depicting an example published object in accordance with an embodiment of the invention;

FIG. 8 is an object interface diagram depicting an example capability object in accordance with an embodiment of the invention;

FIG. 9 is an object interface diagram depicting an example MeContact object in accordance with an embodiment of the invention;

FIG. 10 is an object interface diagram depicting an example conference object in accordance with an embodiment of the invention;

FIG. 11 is a flowchart depicting example steps performed by the collaboration services platform in accordance with an embodiment of the invention; and

FIG. 12 is a flowchart depicting further example steps performed by the collaboration services platform in accordance with an embodiment of the invention.

### DETAILED DESCRIPTION OF THE INVENTION

Prior to proceeding with a description of the various embodiments of the invention, a description of a computer in which the various embodiments of the invention may be practiced is now provided. Although not required, the invention will be described in the general context of computer-executable instructions, such as program modules, being executed by a computer. Generally, programs include routines, objects, components, data structures and the like that perform particular tasks or implement particular abstract data types. The term “program” as used herein may connote a single program module or multiple program modules acting in concert. The terms “computer” and “computing device” as used herein include any device that electronically executes one or more programs, such as personal computers (PCs), hand-held devices, multi-processor systems, microprocessor-based programmable consumer electronics, network PCs, minicomputers, tablet PCs, laptop computers, consumer appliances having a microprocessor or microcontroller, routers, gateways, hubs and the like. The invention may also be employed in distributed computing environments, where tasks are performed by remote processing devices that are linked through a communications network. In a distributed computing environment, programs may be located in both local and remote memory storage devices.

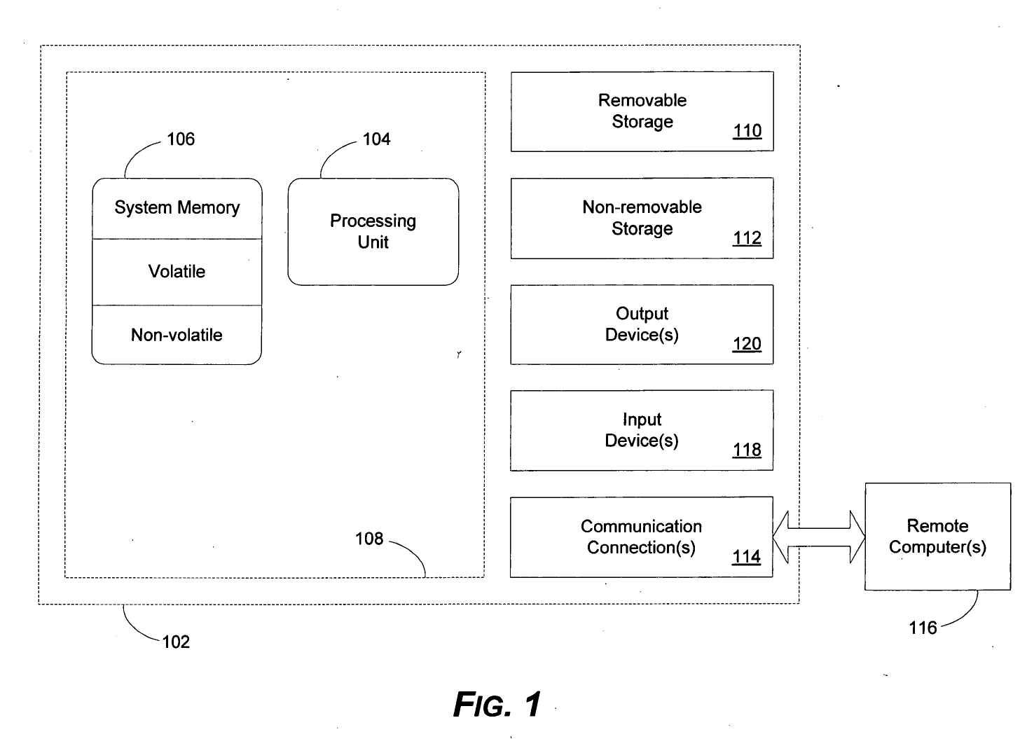

Referring to FIG. 1, an example of a basic configuration for the computer 102 on which aspects of the invention described herein may be implemented is shown. In its most basic configuration, the computer 102 typically includes at least one processing unit 104 and memory 106. The processing unit 104 executes instructions to carry out tasks in accordance with various embodiments of the invention. In carrying out such tasks, the processing unit 104 may transmit electronic signals to other parts of the computer 102 and to devices outside of the computer 102 to cause some result. Depending on the exact configuration and type of the computer 102, the memory 106 may be volatile (such as RAM), non-volatile (such as ROM or flash memory) or some combination of the two. This most basic configuration is illustrated in FIG. 1 by dashed line 108.

The computer 102 may also have additional features/functionality. For example, computer 102 may also include additional storage (removable 110 and/or non-removable 112) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 102. Any such computer storage media may be part of computer 102.

The computer 102 preferably also contains communications connections 114 that allow the device to communicate with other devices such as remote computer(s) 116. A communication connection is an example of a communication medium. Communication media typically embody computer readable instructions, data structures, program modules or other data in a modulated data signal such as a carrier wave or other transport mechanism and includes any information delivery media. By way of example, and not limitation, the term “communication media” includes wireless media such as acoustic, RF, infrared and other wireless media. The term “computer-readable medium” as used herein includes both computer storage media and communication media.

The computer 102 may also have input devices 118 such as a keyboard/keypad, mouse, pen, voice input device, touch input device, etc. Output devices 120 such as a display, speakers, a printer, etc. may also be included. All these devices are well known in the art and need not be described at length here.

In the description that follows, the invention will be described with reference to acts and symbolic representations of operations that are performed by one or more computing devices, unless indicated otherwise. As such, it will be understood that such acts and operations, which are at times referred to as being computer-executed, include the manipulation by the processing unit of the computer of electrical signals representing data in a structured form. This manipulation transforms the data or maintains it at locations in the memory system of the computer, which reconfigures or otherwise alters the operation of the computer in a manner well understood by those skilled in the art. The data structures where data is maintained are physical locations of the memory that have particular properties defined by the format of the data. However, while the invention is being described in the foregoing context, it is not meant to be limiting as those of skill in the art will appreciate that various of the acts and operation described hereinafter may also be implemented in hardware.

In an embodiment of the invention, a computer software architecture provides an extensible, flexible, maintainable and scalable collaboration platform. Aspects of the architecture may be incorporated into a suitable networked computing environment. The architecture may enable and/or extend integrated collaboration with conventional computer software applications. In particular, the architecture may provide for comprehensive collaborative contact management, including current contact presence in a networked computing environment and current contact capabilities, for example, with respect to available collaborative activities.

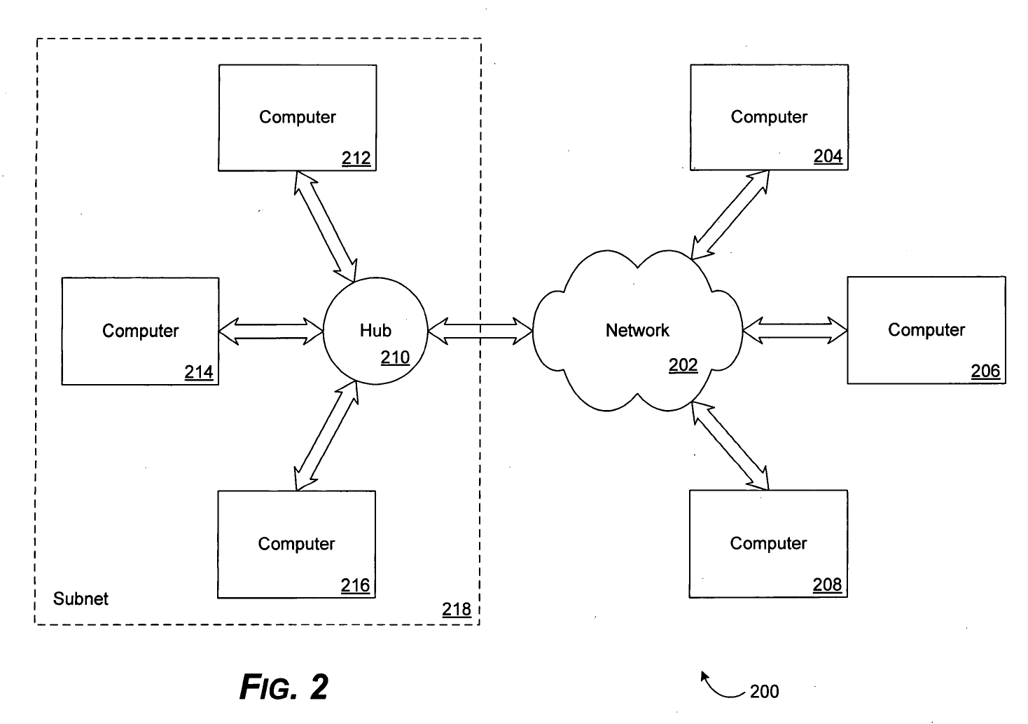

FIG. 2 depicts an example networked computing environment 200 suitable for incorporating an embodiment of the invention. In the networked computing environment a network 202 communicatively connects computers 204, 206 and 208 to a networking hub 210. The network 202 may be a local area network (LAN), a metropolitan area network (MAN), a wide area network (WAN), a personal area network (PAN) or a combination thereof. The network 202 may incorporate any suitable networking components such as hubs, gateways, routers, bridges, ports and the like, as well as any suitable computer readable medium. For example, the computers 204, 206, 208 and the networking hub 210 may each be instances of the computer 102 (FIG. 1).

The networking hub 210 may communicatively connect computers 212, 214 and 216. The networking hub 210 and the computers 212, 214 and 216 may together be regarded as an example of a sub-network or subnet 218, although, of course, not a limiting example. The computers 212, 214 and 216 are said to be on the same subnet, and may enjoy privileged network communication with respect to each other as a result. For example, even though each computer 204, 206, 208, 212, 214 and 216 may send point-to-point type messages to each other computer 204, 206, 208, 212, 214 and 216, the subnet 218 may be configured such that broadcast type messages in the subnet 218 are received by those computers 212, 214 and 216 in the subnet 218.

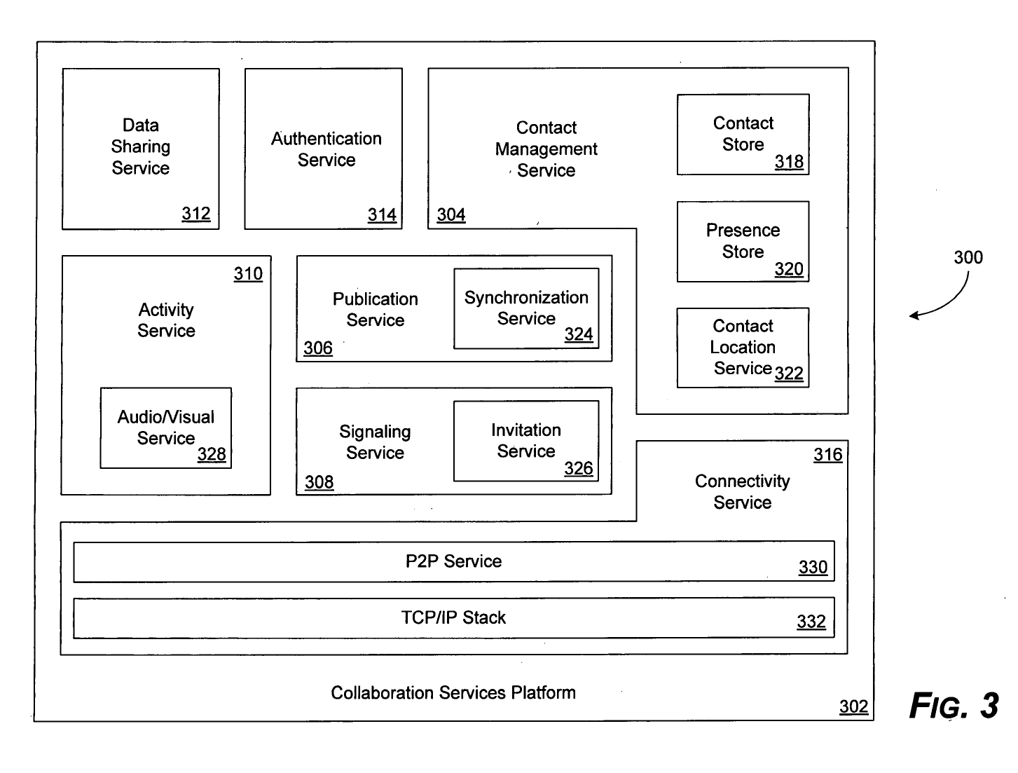

The extensible, flexible, maintainable and/or scalable attributes of the collaboration platform may arise from one or more aspects of its modular structure, its modular structure as a whole, modes of interaction between ones of the modules and/or the interaction patterns of the modular structure as a whole. FIG. 3 depicts an example computer software architecture 300 in accordance with an embodiment of the invention. Each aspect of the architecture 300 may be present at each computer 204, 206, 208, 212, 214 and 216 (FIG. 2), however, each embodiment of the invention is not so limited. Aspects of the architecture 300 may be suitably distributed across any suitable subset of the networked computing environment 200, including the networked computing environment 200 as a whole. Different versions of the architecture 300 may be present at different computers, and the degree to which each version of the architecture 300 is compatible with each other version of the architecture 300 may vary.

The architecture 300 may include a collaboration services platform 302. The collaboration services platform 302 may include a contact management service 304, a publication service 306, a signaling service 308, an activity service 310, a data sharing service 312, an authentication service 314 and a connectivity service 316. The contact management service 304 may include a contact store 318, a presence store 320, and a contact location service 322. The publication service 306 may include a synchronization service 324. The signaling service 308 may include an invitation service 326. The activity service 310 may include an audio/visual (A/V) service 328. The connectivity service 316 may include a peer-to-peer (P2P) service 330, and a conventional transport control protocol and internet protocol (TCP/IP) stack 332. Each service 304, 306, 308, 310, 312, 314, 316 may include and/or be incorporated into a peer capable of sending and receiving messages implementing the service.

In an embodiment of the invention, the contact management service 304 provides effective access to collaborators, that is, to users of the collaborative services platform 302. For example, the contact management service 304 may provide contact information for some or all of the users of the collaborative services platform 302. The contact management service 304 may maintain a database of contacts in one or more data stores. Each contact may be a potential collaborator, that is, a user of the collaboration services platform may attempt to engage in one or more collaboration activities with each contact. The contact management service 304 may provide one or more user interfaces, including graphical user interfaces (GUI), that present the contacts, for example, for selection by the user and/or so that the user may invoke a collaboration services platform 302 action with respect to a particular contact.

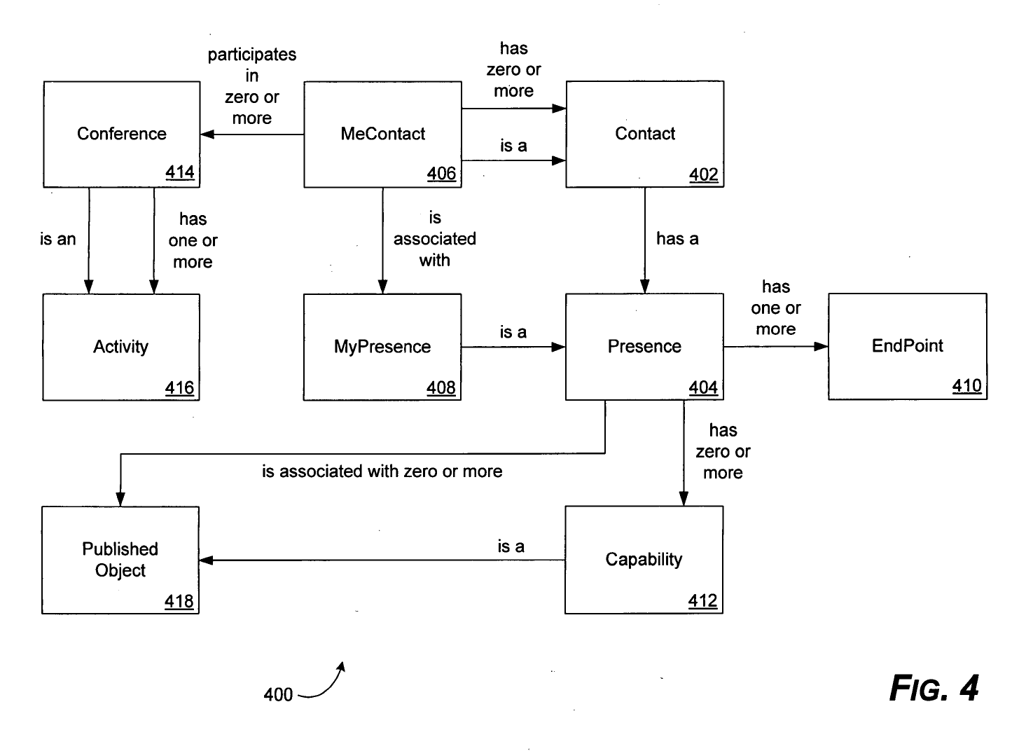

The contact store 318 may store contact objects and “MeContact” objects (described in more detail below with reference to FIG. 4). The presence store 320 may store presence objects (also described in more detail below with reference to FIG. 4) for the contact objects. In an embodiment of the invention, presence data changes more frequently than contact data, so that the separate data stores 318, 320 may be optimized for different object update frequencies.

The contact location service 322 may provide one or more of a variety of location data with respect to a given contact. Physical proximity may be an aspect of contact location, for example, one or more proxies for physical location may be utilized to estimate a physical distance of a contact from the user. Signal strength at a radio receiver is an example of a physical distance proxy. Virtual location may be another aspect of contact location. For example, a contact may be active at one or more networks, such as network 202 of FIG. 2, and/or one or more network nodes, such as computers 204, 206, 208, 212, 214 and 216. In addition, a contact may be registered but inactive, or online but undiscovered, or have some other suitable locative status. The contact location service 322 may query a suitable registry and/or initiate, for example, a peer-to-peer search or a peer-to-peer name resolution mechanism, in order to locate a particular contact.

The publication service 306 may provide access to data published by contacts. In an embodiment of the invention, interested users may subscribe to objects published by contacts and receive notification whenever the published objects are updated by the publishing contact. The synchronization service 324 may be responsible for maintaining a database of publication subscriptions. In particular, the publication services 206 may provide access to presence information published by contacts.

The signaling service 308 may provide for the establishment and termination of collaborative conferences between contacts present in the networked computing environment 200 (FIG. 2), as well as for updating parameters of a conference in progress. In an embodiment of the invention, establishment, update and termination of collaborative conferences is provided in accordance with publish/subscribe semantics. In an embodiment of the invention, the signaling service 308 incorporate an implementation of a session initiation protocol (SIP) such as the session initiation protocol described by Handley et al., “SIP: Session Initiation Protocol,” Internet Engineering Task Force (IETF) Request for Comments (RFC) 2543, March 1999.

The invitation service 326 may enable invitations and related messages to be sent to and from contacts. For example, a system user accessing the networked computing environment 200 (FIG. 2) at one computer 212 may invite a contact at some other computer(s) 204, 206, 208, 212, 214 and/or 216 to participate in a collaborative activity. The invitation service 326 may utilize the contact location service 322 to locate the contact and deliver the invitation. The invitation service 326 may include a variety of user interfaces such as graphical user interfaces (GUI) for presenting invitation details to an invitee and enabling the invitee to accept, decline and/or explicitly ignore the invitation.

The activity service 310 may implement collaborative activities and/or provide support for the integration of collaborative applications into the collaboration services platform 302. For example, the activity service 310 may provide collaboration services platform 302 compliant application programming interfaces (APIs) to conventional collaboration applications. Compliant APIs may include functionality for querying a particular contact or computer 204, 206, 208, 212, 214, 216 (FIG. 2) with respect to activity capabilities, and for ascertaining application-specific invitation requirements. The audio/visual services 328 are an example of collaboration activities that are suitable for incorporation into the activity service 310.

The data sharing service 312 may enable sharing of data in any suitable format including files, documents, streams and objects. The data sharing service 312 may provide for data transfer, data replication and/or data synchronization. Data sharing may be enabled and disabled based on contact, participation in an activity, participation in a conference, and/or any suitable access control list (ACL) entry such as networked computing environment 200 (FIG. 2) user group.

The authentication service 314 may source and verify authentication credentials, for example, authentication credentials for contacts and other activity and conference participants. The authentication service 314 may enable the classification of contacts into trusted contacts and untrusted contacts. The authentication service 314 may enable contacts to be trusted independent of contact location and/or in accordance with sophisticated networked computing environment 200 (FIG. 2) presence.

In an embodiment of the invention, the connectivity service 316 enables communication between collaboration services platform 302 service instances throughout the networked computing environment 200 (FIG. 2), for example, between a first signaling service 308 instance at the computer 212 and a second signaling service 308 instance at the computer 208. The communication facilities of the connectivity service 316 may be made available with an application programming interface (API) so that other collaboration service platform 302 services 304, 306, 308, 310, 312, 314 may communicate between instances independent of the underlying transport mechanism.

The connectivity service 316 may include a TCP/IP stack 332 and/or higher level communication application programming interfaces such as the Microsoft® Windows® Sockets 2 (Winsock) API as described in the Windows® Sockets 2 section of the Microsoft® Windows® Platform Software Development Kit (SDK) in the Microsoft Developer Network (MSDN®) Library dated March, 2005. The peer-to-peer (P2P) service 330 may provide connectivity in an overlay network of the network computing environment 200. For example, the peer-to-peer service 330 may be provided in accordance with the peer-to-peer application programming interface described in the Windows® Peer-to-Peer Networking section of the Microsoft® Windows® Platform Software Development Kit (SDK) in the Microsoft Developer Network (MSDN®) Library dated March, 2005, including the graphing, grouping, identity manager, and peer name resolution protocol (PNRP) namespace provider application programming interfaces.

The services 304, 306, 308, 310, 312, 314 and 316 of the collaboration services platform 302 may be implemented with a set of programmatic objects including a set of collaboration objects interrelated in a collaboration object model. FIG. 4 depicts an example set of collaboration objects and an example collaboration object model 400 in accordance with an embodiment of the invention. The collaboration object model 400 may include a contact object 402, a presence object 404, a MeContact object 406 and a MyPresence object 408, an endpoint object 410, a capability object 412, a conference object 414, an activity object 416, and a published object 418. Of course, the collaboration services platform 302 may include many instances of each type of collaboration object 402, 404, 406, 408, 410, 412, 414, 416 and 418.

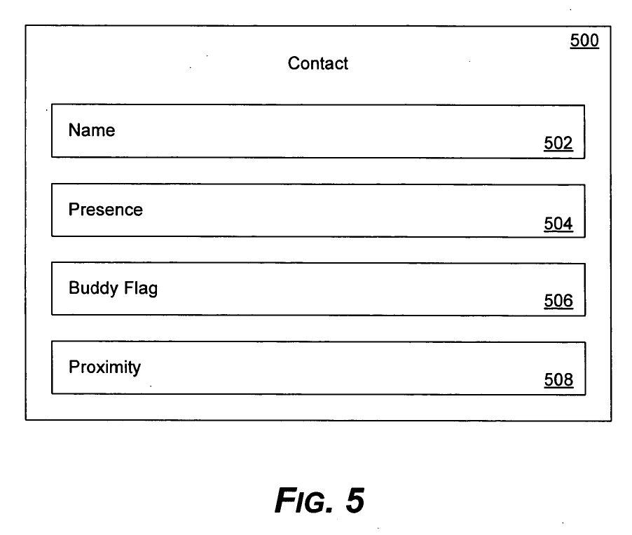

The contact object 402 may incorporate suitable attributes for representing a collaborative participant and/or a user of the collaborative services platform 302 (FIG. 3). In particular, the contact object 402 may reference a collaborative presence, for example, a contact's presence in the networked computing environment 200 (FIG. 2). In an embodiment of the invention, the contact object 402 references a collaborative presence by referencing an instance of the presence object 404. An example contact object 402 is described in more detail below with reference to FIG. 5.

The presence object 404 may incorporate suitable attributes for representing a collaborative presence, for example, a set of computers 204, 206, 208, 212, 214 and/or 216 (FIG. 2) of the networked computing environment 200 at which a particular collaboration services platform 302 user has been active at some time in the recent past, where the “recent” past may vary from seconds to hours, days and even years depending upon the collaborative context. The presence object 404 may reference one or more endpoint object 410 instances representing networked computing environment 200 locations. Endpoint objects 410 needn't correspond one-to-one with computers 204, 206, 208, 212, 214, 216 of the networked computing environment 200, for example, because an endpoint object 410 may correspond to a peer in an overlay network of the networked computing environment 200.

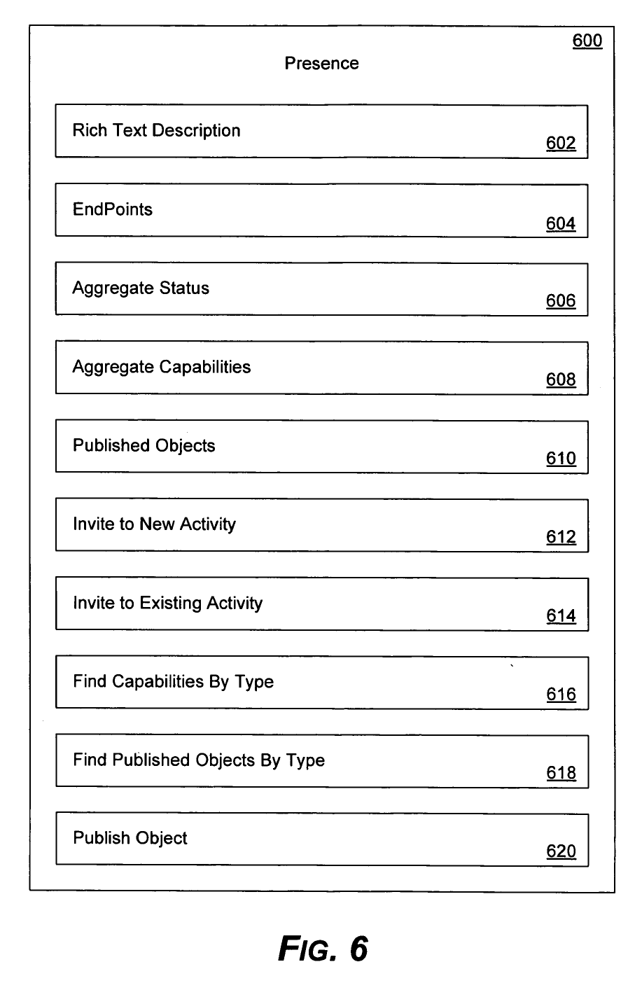

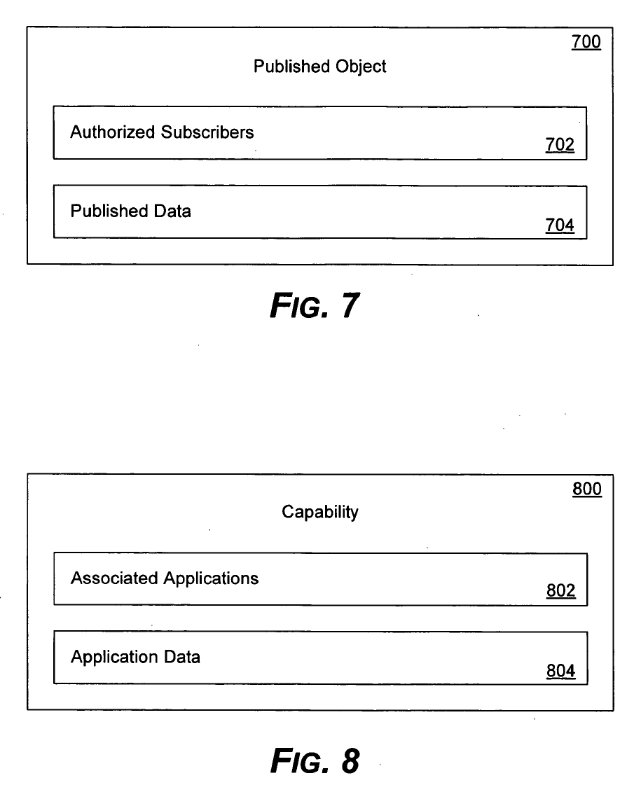

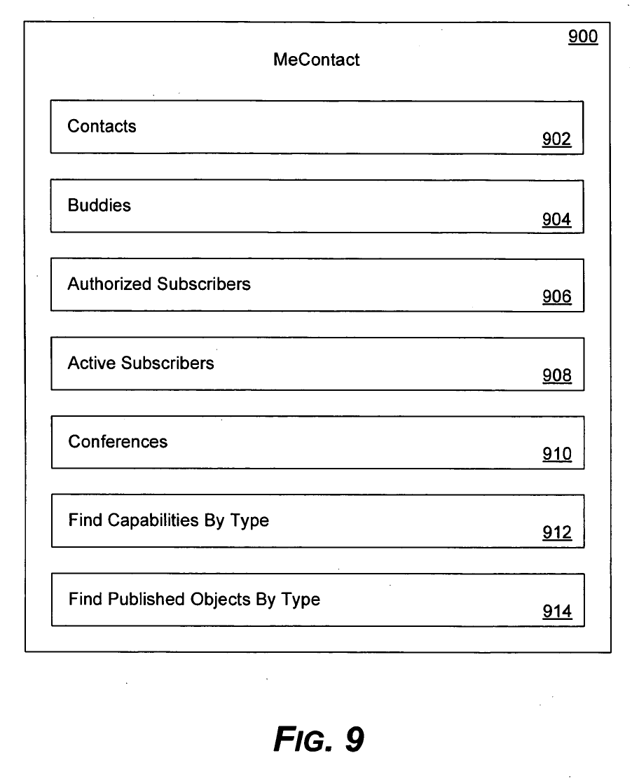

The presence object 404 may further reference zero or more capability object 412 instances representing, for example, collaborative capabilities at one or more collaborative endpoints and/or an aggregate collaborative capability across some or all endpoints associated with the presence object 404. In addition, the presence object 404 may reference zero or more published object 418 instances. An example presence object 404 is described in more detail below with reference to FIG. 6. An example published object 418 is described in more detail below with reference to FIG. 7. An example capability object 412 is described in more detail below with reference to FIG. 8.

The MeContact object 406 may be a type of contact object 402, and may polymorphically inherit the attributes and behavior of the contact object 402. The MeContact object 406 may be differentiated from the contact object 402 because of the special role a collaboration services platform user's own contact information may play relative to the contact information of other users. For example, the MeContact object 406 may reference zero or more contact object 402 instances representing that particular user's known collaborative contacts. The MeContact object 406 needn't reference, for example, other MeContact object 406 instances. In an embodiment of the invention, unnecessary complexity is thus avoided contributing to the extensibility, flexibility, maintainability and/or scalability of the collaboration services platform 302 (FIG. 3).

The MeContact object 406 may further reference a MyPresence object 408 instance. The MyPresence object 408 may be a type of presence object 404, and may polymorphically inherit the attributes and behavior of the presence object 404. Again, the MyPresence object 408 may be differentiated from the presence object 404 because of the special role a collaboration services platform user's own presence may play relative to the presence of other users. For example, in an embodiment of the invention, the user may explicitly update their own MyPresence object 408 instance, but not the presence object 404 instances of other users.

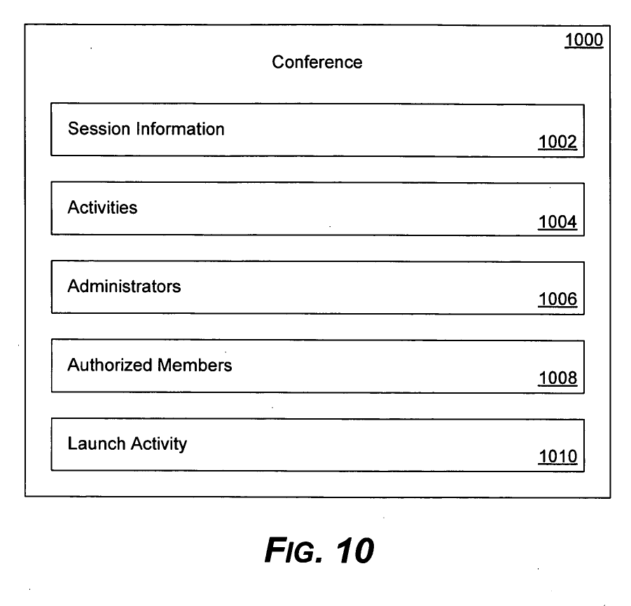

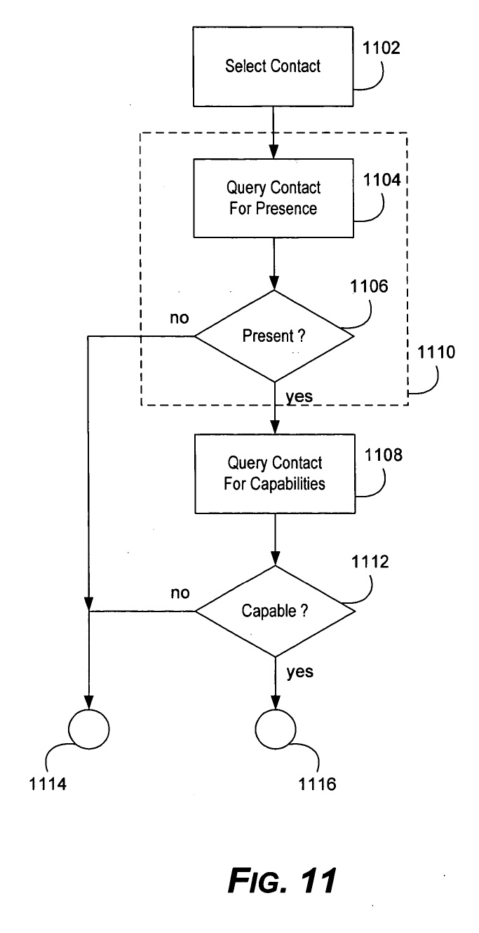

In addition, the MeContact object 406 may reference zero or more conference object 414 instances representing collaborative conferences in which the user associated with the MeContact object 406 is currently and/or recently participating, along with other collaboration services platform users. The conference object 414 may reference one or more activity object 416 instances representing collaborative activities. In an embodiment of the invention, the conference object 414 is a type of activity object 416, and may polymorphically inherit the attributes and behavior of the activity object 416. As a result of being a type of activity object 416, the activity object 416 instances referenced by the conference object 414 may be conference object 414 instances. An example MeContact object 406 is described in more detail below with reference to FIG. 9. An example conference object 414 is described in more detail below with reference to FIG. 10.

Each collaborative object 402, 404, 406, 408, 410, 412, 414, 416 and 418 may offer an application programming interface for creating and deleting collaborative object 402, 404, 406, 408, 410, 412, 414, 416 and 418 instances, as well as for suitable queries and manipulations of collaborative object 402, 404, 406, 408, 410, 412, 414, 416 and 418 attributes. In an embodiment of the invention, where collaborative objects 402, 404, 406, 408, 410, 412, 414, 416 and 418 are described as referencing other collaborative objects 402, 404, 406, 408, 410, 412, 414, 416 and 418, the referenced objects, or copies thereof, may instead be incorporated into and/or made integral to the referencing object. One programmatic object may reference another with any suitable programmatic reference mechanism. Suitable programmatic reference mechanisms include pointers, explicit references, associated hash codes and their equivalents, as well as program language features designed specifically for the purpose.

The programmatic objects 402, 404, 406, 408, 410, 412, 414, 416 and 418 introduced above with reference to FIG. 4 are now described in more detail. Each programmatic object 402, 404, 406, 408, 410, 412, 414, 416 and 418 may include one or more application programming interface elements. Each application programming interface element may include one or more interface specifications that specify a manner in which computer 102 (FIG. 1) system components, including collaboration services platform 302 (FIG. 3) services, may configure, control and/or interact with the programmatic object 402, 404, 406, 408, 410, 412, 414, 416 and 418. As will be apparent to one of skill in the art, the interface specifications may include object attribute specifications, variable specifications, function call specifications, program object specifications, message specifications such as request/response message pairs, and/or any other suitable programming interface specification.

FIG. 5 depicts an example contact object 500 in accordance with an embodiment of the invention. The contact object 500 is suitable for incorporation in the collaboration object model 400 (FIG. 4). The contact object 500 may incorporate application programming interface elements including a name element 502, a presence element 504, a buddy flag element 506, and a proximity element 508.

The name element 502 may include a friendly name for a contact associated with the contact object 500. The friendly name may be encoded, for example, as a rich text string. The presence element 504 may include a reference to a presence object 404 (FIG. 4) instance.

The buddy flag element 506 may include an indicator that the contact associated with the contact object 500 is categorized as a “buddy” class contact. Contacts categorized as buddies may be privileged in a variety of ways. For example, a buddy may be a trusted contact, buddies may be given priority, for example, invitation priority, and buddies may be automatically included in the set of contacts to which a collaboration services platform user subscribes, for example, for presence data. Buddy class contacts may be computationally more expensive than ordinary contacts, and their number may be limited, for example, with a test embedded in the buddy flag application programming interface element 506.

The proximity element 508 may include a physical proximity metric and/or a virtual proximity metric. For example, the physical proximity metric may be a measure of signal strength received at a wireless network interface. Of course, the proximity application programming interface element 508 need not be limited to a single metric in response to a proximity query. For example, the proximity query may request a raw proximity metric, a time-averaged proximity metric, a quantized proximity metric (“signal strength bars”) and/or any suitable proximity metric.

FIG. 6 depicts an example presence object 600 in accordance with an embodiment of the invention. The presence object 600 is suitable for incorporation in the collaboration object model 400 (FIG. 4). The presence object 600 may incorporate application programming interface elements including a rich text description element 602, an endpoints element 604, an aggregate status element 606, an aggregate capabilities element 608, a published objects element 610, an invite to new activity element 612, an invite to existing activity element 614, a find capabilities by type element 616, a find published objects by type element 618, and a publish object element 620.

The rich text description element 602 may include a rich text string describing the networked computing environment 200 (FIG. 2) presence associated with the presence object 600. Simple examples include “Currently in Building 9,” “Playing Halo®, Level 4,” and “Unavailable.” The endpoints element 604 may include a set of collaborative endpoints that are active, recently active, and/or capable of becoming active participants in one or more collaborative activities. Examples of suitable collaborative endpoints include computers 204, 206, 208, 212, 214 and 216, and peers of an overlay network of the networked computing environment 200.

The aggregate status element 606 may include an aggregate presence status indicator representative of collaborative presence across the set of collaborative endpoints. Each collaborative endpoint may have an associated presence status, for example, ONLINE, AWAY, or BUSY. The aggregate presence status associated with a set of endpoints need not be the same as the status associated with any one of the endpoints in the set. Even when the aggregate presence status is the same as at least one of the endpoints in the set, it may be different from one or more of the others.

Aggregate presence status may be determined with one or more of a variety of aggregate presence status algorithms. The presence status levels may be ranked, and the aggregate status may be set to the highest ranked status in a set of endpoints. Aggregate status may be weighted average of individual status values, or other suitable linear or nonlinear transformation of individual status values. The individual status values may also be suitably sorted before being transformed. The aggregate presence status algorithm utilized may depend upon the number of individual endpoints in the set.

The aggregate capabilities element 608 may include a collection of aggregate capabilities associated with a collaborative presence. Each individual endpoint in the collaborative presence may have associated therewith a set of capabilities, for example, capabilities with respect to collaborative activities. The aggregate capabilities may be a simple aggregate of each of the capabilities of each of the individual endpoints. On the other hand, the collection of aggregate capabilities may be limited to those capabilities that are present at each of the individual endpoints. Combinations of these extremes are possible, as are more sophisticated aggregate capabilities determination algorithms. For example, the collection of aggregate capabilities may be a result of a weighted averaging process, or other suitable linear or nonlinear transformation of the capabilities of individual endpoints. In addition, an aggregate capability rank or percentage may be associated with each capability in the collection of aggregate capabilities.

The published objects element 610 may include a collection of published objects associated with the collaborative presence. While the capability object 412 (FIG. 4) may be a type of published object 418, the two are differentiated in that capabilities associated with instances of the capability object 412 are typically long-lived (e.g., on the order of days, weeks, or even years), whereas published data associated with instances of the base published object 418 are typically short-lived (e.g., on the order of seconds, minutes or hours). This differentiation may be exploited to optimize computer system performance.

The invite to new activity element 612 may enable a collaboration services platform 302 (FIG. 3) user to invite a contact associated with the presence object 600 to participate in a new collaborative activity. It may be that an associated conference for hosting the activity does not yet exist, and that one will be created if the invitation is accepted. The invitation may be delivered to each endpoint referenced by the endpoints element 604, only to those endpoints associated with an ONLINE presence status, the invitation may be delivered to each endpoint associated with the collaborative presence in an order, for example, an order determined by the presence status associated with each endpoint in the order, or other suitable invitation delivery strategy.

The invite to existing activity application programming interface element 614 may be preferred when inviting a contact to join an existing conference and/or activity. When a conference and/or activity is already established, some collaborative parameters may not be negotiable, or may be less negotiable, for example, negotiable only within a range determined by collaborative parameters in use by current participants. In addition, less flexibility may limit the endpoints of a presence that qualify for participation and thus that are candidates for receiving an invitation.

The find capabilities by type element 616 may enable a collaboration services platform 302 (FIG. 3) user to query the presence associated with the presence object 600 for capabilities associated with one or more of a plurality of capability types. Examples of capability types include application types such as chat, audio and video, application capabilities such as audio output, audio input, video output, video input, endpoint resources such as bandwidth, audio quality, and video resolution, or any suitable collaborative capability type. The find capabilities by type element 616 may respond to the query with capabilities of individual endpoints and/or aggregate presence capabilities.

The find published objects by type element 618 may enable a collaboration services platform 302 (FIG. 3) user to query the presence associated with the presence object 600 for published objects associated with the presence, for example, the published objects accessible with the published object element 610. The published object type may be determined by an associated rich text string. For example, those published object 418 (FIG. 4) instances associated with the same rich text string may be determined to be of the same type.

The publish object element 620 may enable the publication of data associated with the presence. For example, the set of presence objects maintained by the published objects element 610 may be updated. In an embodiment of the invention, the publish object application programming interface element 620 may be incorporated into the published objects application programming interface element 610.

FIG. 7 depicts an example published object 700 in accordance with an embodiment of the invention. The published object 700 is suitable for incorporation in the collaboration object model 400 (FIG. 4). The published object 700 may incorporate application programming interface elements including an authorized subscribers element 702, and a published data element 704.

The authorized subscribers element 702 may reference one or more contact object 402 (FIG. 4) instances associated with contacts who are authorized to subscribed to the data associated with the published object 700. Data access control may be coarse grained, for example, allow or block, or fine grained, for example, including control over data create, read, update and delete privileges. The published data element 7084 may maintain a set of published data associated with the published object 700. Any suitable set of data may be published in association with the published object 700.

FIG. 8 depicts an example capability object 800 in accordance with an embodiment of the invention. The capability object 800 is suitable for incorporation in the collaboration object model 400 (FIG. 4). The capability object 800 may incorporate application programming interface elements including an associated application element 802, and an application data element 804.

The associated applications element 802 may include a reference to a set of collaborative applications that implement the capability associated with the capability object 800. The application data element 804 may include data and/or a specification of data required to configure each of the set of collaborative applications referenced by the associated applications element 802.

FIG. 9 depicts an example MeContact object 900 in accordance with an embodiment of the invention. The MeContact object 900 is suitable for incorporation in the collaboration object model 400 (FIG. 4). The MeContact object 900 may incorporate application programming interface elements including a contacts element 902, a buddies element 904, an authorized subscribers element 906, an active subscribers element 908, a conferences element 910, a find capabilities by type element 912, and a find published objects by type element 914.

The contacts element 902 may include references to a set of contact object 402 (FIG. 4) instances associated with contacts known to the collaboration services platform 302 (FIG. 3) user associated with the MeContact object 900. The buddies element 904 may include references to a set of contact object 402 (FIG. 4) instances associated with contacts known to the collaboration services platform 302 (FIG. 3) user and that are also buddy class contacts, for example, as indicated by the buddy flag element 506 (FIG. 5) of the contact object 500. Mere presence in the set of contact object 402 instances referenced by the buddies element 904 may indicate that the associated contact is a buddy class contact. The set of contact object 402 instances referenced by the contacts element 902 and the buddies element 904 may overlap, however, in at least one embodiment of the invention, the sets are exclusive.

The authorized subscribers element 906 may include references to a set of contact object 402 (FIG. 4) instances associated with contacts that are authorized to subscribe to published data associated with the MeContact object 900, such as capabilities data. Published data access control may be coarse grained, for example, block or allow access to all published data, or fine grained, for example, create, read, update and/or delete permissions for each published object 418, or combinations thereof.

The active subscribers element 908 may include references to a set of contact object 402 instances associated with contacts that are actively subscribed to data published by the collaboration services platform 302 (FIG. 3) user associated with the MeContact object 900. Of course, contact object 402 instances referenced by the active subscribers element 908 should be in accordance with the permissions maintained by the authorized subscribers element 906.

The conferences element 910 may include references to a set of conference object 414 (FIG. 4) instances associated with conferences in which the collaboration services platform 302 (FIG. 3) user associated with the MeContact object 900 is currently participating, in which the user has recently participated, and/or in which the user will soon participate.

The find capabilities by type element 912 may enable a collaboration services platform 302 (FIG. 3) user to query the contacts associated with the MeContact object 900 for capabilities associated with one or more of the plurality of capability types. For example, the find capabilities by type element 912 may query the contact object 402 (FIG. 4) instances referenced by the contacts element 902, the buddies element 904 and/or the MeContact object 900 itself. The find capabilities by type element 912 may respond to the query with capabilities of individual endpoints and/or aggregate capabilities. The find published objects by type element 914 may enable the user to query the contacts associated with the MeContact object 900 for published data. As with the find capabilities by type element 912, the find published objects by type element 914 may query the published object 418 instances referenced by the contacts element 902, the buddies element 904 and/or the MeContact object 900 itself.

FIG. 10 depicts an example conference object 1000 in accordance with an embodiment of the invention. The conference object 1000 is suitable for incorporation in the collaboration object model 400 (FIG. 4). The conference object 1000 may incorporate application programming interface elements including a session information element 1002, an activities element 1004, an administrators element 1006, an authorized members element 1008, and a launch activity element 1010.

In an embodiment of the invention, roles of a conference, for example, a conference associated with the conference object 1000, include organizing, managing and/or maintaining one or more collaborative activities in which one or more collaboration services platform 302 (FIG. 3) users are participating. The session information element 1002 may include conference level session information. Performance optimizations may be achieved by collecting activity level session information at the conference level. The activities element 1004 may include references to one or more activity object 416 (FIG. 4) instances.

The administrators element 1006 may reference one or more contact object 402 (FIG. 4) instances associated with contacts that are authorized to act as administrators for the conference. Administrative privileges may include adding and removing authorized participants and/or activities. The authorized members element 1008 may reference one or more contact object 402 instances associated with contacts that are authorized to participate in activities associated with the conference. Authorization may be coarse grained, for example, allow or block a particular contact from participating in all conference activities, fine grained, for example, permissions may be granted to launch new activities or end existing activities, to participate fully in individual activities or to participate in a limited way (e.g., “observer status”), or combinations thereof.

The launch activity element 1010 may add a new activity to the conference. Joining and leaving activities may be managed by the conference, by the activity, or by a combination of the two. In each case, the conference object 1000 application programming interface elements may enforce accordance with the administrators element 1006 and/or the authorized members element 1008.

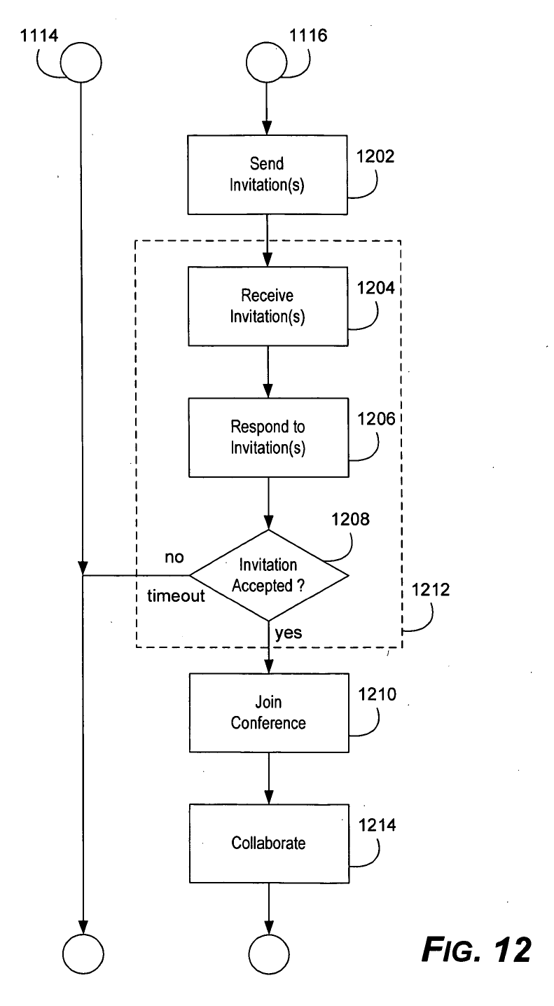

Detailed methods performed, for example, by the collaboration services platform 302 (FIG. 3) and in accordance with the collaboration object model 400 (FIG. 4) are now described. FIG. 11 depicts example steps performed by the collaboration services platform 302 in accordance with an embodiment of the invention. At step 1102, a contact object 402 instance may be selected. For example, a contact object 402 instance stored in the contact store 318 may be selected with a user interface of the contact management services 304.

At step 1104, the selected contact object 402 (FIG. 4) instance may be queried for its associated presence object 404 instance. For example, the presence element 504 (FIG. 5) of the selected contact object 500 may be utilized to access the associated presence object 404 instance.

At step 1106, it may be determined if the contact associated with the selected contact object 402 (FIG. 4) instance is present in the networked computing environment 200 (FIG. 2). For example, the aggregate presence status of the contact may be obtained from the aggregate status element 606 of the presence object 600 retrieved at step 1104, and, if the aggregate presence status of the contact is ONLINE, then the contact may be determined to be present. If the contact is determined to be present, the procedure may progress to step 1108. Otherwise the procedure may exit. The contact is unavailable for collaboration at this time.

Alternatively, steps 1104 and 1106 may be replaced with steps that subscribe to the presence information of the selected contact and wait until a notification indicates that the selected contact is present before proceeding to step 1108. This alternative is indicated with dashed line 1110.

At step 1108, the selected contact object 402 (FIG. 4) may be queried for a set of associated capability object 412 instances. For example, the find capabilities by type element 616 (FIG. 6) of the presence object 404 instance retrieved at step 1104 (and/or steps 1110) may be utilized to obtain the pertinent set of capabilities. The particular set of capabilities to be examined may depend upon the target collaborative activity or activities. For example, a conference involving voice may trigger a check for audio input capability. At step 1112, it may be determined if the selected contact has the required capabilities. If the selected contact does have the required capabilities, the procedure may progress to step 1202 of FIG. 12. Otherwise the procedure may exit. Step 1112 needn't be limited to a simple test. Step 1112 may include a negotiation, for example coordinated by the signaling service 308 (FIG. 3), to determine if any of the set of capabilities are sufficient for the target activity or activities.

FIG. 12 depicts further example steps performed by the collaboration services platform 302 in accordance with an embodiment of the invention. The steps of FIGS. 11 and 12 are connected by circles labeled 1114 and 1116. Having determined that the selected contact is both present in the networked computing environment 200 (FIG. 2) and capable of participating in the desired collaborative activity or activities, one or more invitations may be sent to the selected contact at step 1202. For example, an invitation may be sent by the invitation service 326 (FIG. 3) at the computer 212 (FIG. 2).

At step 1204, the one or more invitations may be received by the selected contact. For example, one of the invitations may be received by the invitation service 326 (FIG. 3) at the computer 208 (FIG. 2). At step 1206, the selected contact may respond to the one or more invitations. For example, the selected contact may utilize a user interface of the invitation service 326 at the computer 208 to respond to one of the invitations.

At step 1208, it may be determined if the invitation was accepted. For example, the invitation service 326 at the computer 212 may receive the response sent at step 1206, and the contents of the response may determine if the invitation is accepted. If the invitation is accepted, the procedure may progress to step 1210. Otherwise the procedure may exit.

Steps 1204, 1206 and 1208 are marked with dashed line 1212 to highlight the possibilities for procedural variations when responding to invitations. One reason to send out multiple invitations to the same activity is that the networked computing environment 200 (FIG. 2) presence of the selected contact may encompass multiple endpoints. For example, a collaboration services platform 302 (FIG. 3) user may send three invitations to the same activity from computer 212 to the computers 216, 206 and 208. For example, computer 216 may be an office desktop PC of the selected contact, computer 206 may be a laptop of the selected contact and computer 208 may be a personal digital assistant (PDA) of the selected contact. The invitation may be displayed to the selected contact at more than one endpoint. For example, the selected contact may decline or ignore the invitation at the computer 208 (the PDA in this example), but accept the invitation at the computer 206 (the laptop). A possibility is that the selected contact simply doesn't respond to the invitation. This may result in a timeout and an exit of the procedure.

Another possibility for steps 1212 is that the collaboration services platform 302 (FIG. 3) user at computer 212 (FIG. 2) sends out an invitation to an activity to each other computer 214 and 216 in the subnet 218. In this case, each contact may respond in parallel.

Having accepted the invitation, at step 1210, the selected contact may join an associated conference for the collaborative activity. For example, the conference may be hosted by at the computer 212 (FIG. 2) and the selected contact may join the conference from the computer 206 utilizing the signaling service 308 (FIG. 3) and/or the activity service 310. At step 1214, collaboration incorporating the activity may occur.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computerized system for collaboration, comprising:
a connectivity service configured to, at least, provide communicative connectivity between a plurality of users of a collaborative services platform;
an activity service configured to, at least, provide at least one collaborative activity in which at least some of the plurality of users are capable of participating; and
a contact management service configured to, at least, maintain contact information for each of the plurality of users, the contact information comprising an indication of collaborative activities in which the user is capable of participating.

2. The system of claim 1, further comprising a publication service configured to, at least:
accept subscriptions to at least some of the contact information maintained by the contact management service; and
notify subscribers of changes to the contact information.

3. The system of claim 1, further comprising a signaling service configured to, at least:
coordinate verification that at least two of the plurality of users of the collaborative services platform are capable of participating in said at least one collaborative activity; and
coordinate establishment of a collaborative conference between said at least two of the plurality of users, the collaborative conference comprising said at least one collaborative activity.

4. The system of claim 1, wherein the contact management service comprises a contact location service configured to, at least, determine a location for any of the plurality of users of the collaborative services platform.

5. The system of claim 1, wherein the connectivity service, the activity service, and the contact management service are incorporated into a single executable module.

6. The system of claim 1, wherein maintaining contact information for each of the plurality of users comprises maintaining a contact programmatic object for each of the plurality of users, the contact programmatic object comprising an indication as to whether the associated user is a privileged contact of another user.

7. A computer readable medium having thereon a set of computer-executable programmatic objects for collaboration, comprising:
at least one contact programmatic object representing at least one user of a collaborative services platform;
at least one conference programmatic object representing at least one collaborative conference in which a plurality of users of the collaborative services platform are capable of participating; and
a MeContact programmatic object representing a further user of the collaborative services platform, the MeContact programmatic object referencing, at least:
at least one of said at least one contact programmatic object; and
at least one of said at least one conference programmatic object.

8. The medium of claim 7, wherein the MeContact programmatic object comprises an application programming interface, the application programming interface comprising:
a contacts element enabling access to the referenced at least one contact programmatic object; and
a conferences element enabling access to the referenced at least one conferences object programmatic object.

9. The medium of claim 8, wherein the application programming interface of the MeContact programmatic object further comprises a buddies element enabling access to ones of said at least one contact programmatic object associated with privileged contacts of the further user represented by the MeContact programmatic object.

10. The medium of claim 1, wherein the application programming interface of the MeContact programmatic object further comprises:
an authorized subscribers element enabling access to ones of said at least one contact programmatic object associated with contacts that are authorized to subscribe to data published by the further user represented by the MeContact programmatic object; and
an active subscribers element enabling access to ones of said at least one contact programmatic object associated with contacts that are subscribed to data published by the further user represented by the MeContact programmatic object.

11. The medium of claim 1, wherein the application programming interface of the MeContact programmatic object further comprises:
a find capabilities by type element enabling a query of the networked computing environment presence of said further user for capabilities of a specified type; and
a find published objects by type element enabling a query of the networked computing environment presence of said further user for published objects of a specified type.

12. The medium of claim 1, wherein each conference programmatic object references at least one activity programmatic object representing at least one collaborative activity in which at least some of the plurality of users of the collaborative services platform are capable of participating.

13. The medium of claim 1, wherein each contact programmatic object references a presence programmatic object representing a networked computing environment presence of the user of the collaborative services platform associated with the contact programmatic object.

14. A computer readable medium having thereon a set of computer-executable programmatic objects for collaboration, comprising:
at least one endpoint programmatic object representing at least one networked computing environment location;
at least one published object programmatic object representing data published to users of a collaborative services platform; and
a presence programmatic object representing a networked computing environment presence of a user of the collaborative services platform, the presence programmatic object referencing, at least:
at least one of said at least one endpoint programmatic object; and
at least one of said at least one published object programmatic object.

15. The medium of claim 14, wherein the presence programmatic object comprises an application programming interface, the application programming interface comprising:
an endpoints element enabling access to the referenced at least one endpoint programmatic object; and
a published objects element enabling access to the referenced at least one published object programmatic object.

16. The medium of claim 15, wherein the application programming interface of the presence programmatic object further comprises an aggregate status element enabling access to an aggregate presence status determined with respect to the set of endpoints represented by the referenced at least one endpoint programmatic object.

17. The medium of claim 15, wherein the application programming interface of the presence programmatic object further comprises an aggregate capabilities element enabling access to a set of aggregate capabilities determined with respect to the set of endpoints represented by the referenced at least one endpoint programmatic object.

18. The medium of claim 15, wherein the application programming interface of the presence programmatic object further comprises:
an invite to new activity element enabling the user of the collaborative services platform associated with the presence programmatic object to be invited to participate in a new collaborative activity; and
an invite to existing activity element enabling the user to be invited to participate in an existing collaborative activity.

19. The medium of claim 15, wherein the application programming interface of the presence programmatic object further comprises:
a find capabilities by type element enabling a query of the networked computing environment presence of the user for capabilities of a specified type; and
a find published objects by type element enabling a query of the networked computing environment presence of the user for published objects of a specified type.

20. The medium of claim 14, further comprising a MeContact programmatic object representing the user of the collaborative services platform.
